(19) United States
(12) Patent Application Publication
(10) Pub. No.: US 2026/0067342 A1
(43) Pub. Date: Mar. 5, 2026

(54) UTILIZING HYBRID MEDIA SESSIONS TO IMPROVE FLEXIBLILTY IN COMMUNICATION BETWEEN SUBSCRIBERS

(71) Applicant: T-MOBILE INNOVATIONS LLC, Overland Park, KS (US)

(72) Inventors: Harikishore Allu BALAN, Lynnwood, WA (US); Jagannadha Anudeep Varma DATLA, Kent, WA (US)

(21) Appl. No.: 18/820,670

(22) Filed: Aug. 30, 2024

(51) Int. Cl. H04L 65/401; H04L 65/1069

(52) U.S. Cl. CPC H04L 65/401; H04L 65/1069

(57) ABSTRACT

Methods are provided for improved flexibility for subscribers who wish to communicate in real time using different media inputs and/or with more than one subscriber. An indication to convert the voice call session between a first UE and a second UE to a hybrid session may be received by a network function (NF). Based on the indication, the hybrid session is established. The hybrid session comprises a rich communication service (RCS) session and a real-time text (RTT) session. The NF receives a first message from the first UE via the RCS session and communicates a second message to the second UE via the RTT session.

### SUMMARY

The present disclosure is directed, in part to establishing a hybrid session between UEs, substantially as shown and/or described in connection with at least one of the figures, and as set forth more completely in the claims.

According to various aspects of the technology, subscribers are typically limited in the formats available for real-time conversation with another subscriber. For example, subscribers typically communicate in real time via text (e.g., real-time text) or via voice audio (e.g., voice call session). However, many subscribers wish for flexibility in real-time communication such that one subscriber may communicate via text while another subscriber communicates via voice audio. Further, subscribers may wish to communicate in real time with more than one subscriber. By providing a hybrid session enabling one subscriber to communicate in one format while another subscriber communicates in another format, enabling a subscriber to communicate in real time with more than one subscriber, this flexibility may be provided to improve overall subscriber experience.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for establishing a hybrid session in which implementations of the present disclosure may be employed;

FIG. 4 illustrates a flow diagram of an exemplary method for establishing a hybrid session in which implementations of the present disclosure may be employed; and

FIG. 5 illustrates a flow diagram of an exemplary method for establishing a hybrid session in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, subscribers of mobile communications networks communicate in a variety of formats such as text, audio, video, and the like. Subscribers also enjoy having options to select when and how to communicate with other subscribers. For example, when a subscriber is on an active voice call with another subscriber and receives a second incoming voice call, the subscriber may elect whether to hold the current call and answer the second call, end the current call and answer the incoming call, deny answering the second incoming call, or merge the two calls. However, there may be instances where subscribers wish to communicate using different formats. For example, one subscriber wishes to communicate via audio while the other subscriber wishes to communicate via text. In this example, a subscriber who is hard of hearing may prefer to receive text in real time during a voice session rather than via audio. Systems and methods enabling such a hybrid session format are increasingly valuable, as they provide flexibility in media format inputs during communication, and enable subscribers to have more than one real-time communication at a time.

Conventionally, a subscriber is limited in format and options when communicating in real-time with a subscriber. For example, a first subscriber may talk over the phone while a second subscriber receives corresponding, real-time, text messages (e.g., a conventional real-time text session), however, the first subscriber may receive text back from the second subscriber, who instead wishes to receive audio. In this example, the first subscriber may be driving and reading text on their device would distract them from the road, and the other subscriber may be in a meeting, where audio would distract from the meeting. Further, if the first subscriber were to have an incoming call, the subscriber may be forced to deny the call or interrupt (e.g., hold, end, merge) the current stream of communication with the second subscriber. The resulting communication may be less efficient, less safe, and less flexible to subscribers having shifting needs and preferences.

In contrast to conventional solutions and to provide subscribers with dynamic and accessible communication options, the present disclosure is directed to providing a hybrid session including both audio and text inputs. The hybrid session may comprise both a real-time text (RTT) session and a rich communication service (RCS) session, enabling a first subscriber to communicate with a second subscriber via audio, and the second subscriber to communicate with the first subscriber via text. For example, the first subscriber sends a first audio, which is converted to text in real-time. The second subscriber receives the first audio as a first text, and responds with a second text. The second text may be converted to a second audio, which is communicated to the first subscriber as generated synthetic speech. Thus, in this example, the hybrid session may enable the first subscriber to communicate solely through audio and enable the second subscriber to communicate solely through text. In aspects, the subscriber may convert an existing audio call to the hybrid session (e.g., to answer another audio call), or the subscriber may answer an incoming call within the hybrid session (e.g., to maintain an active voice session with another subscriber). This disclosure provides a more flexible and efficient approach to facilitating communication between subscribers.

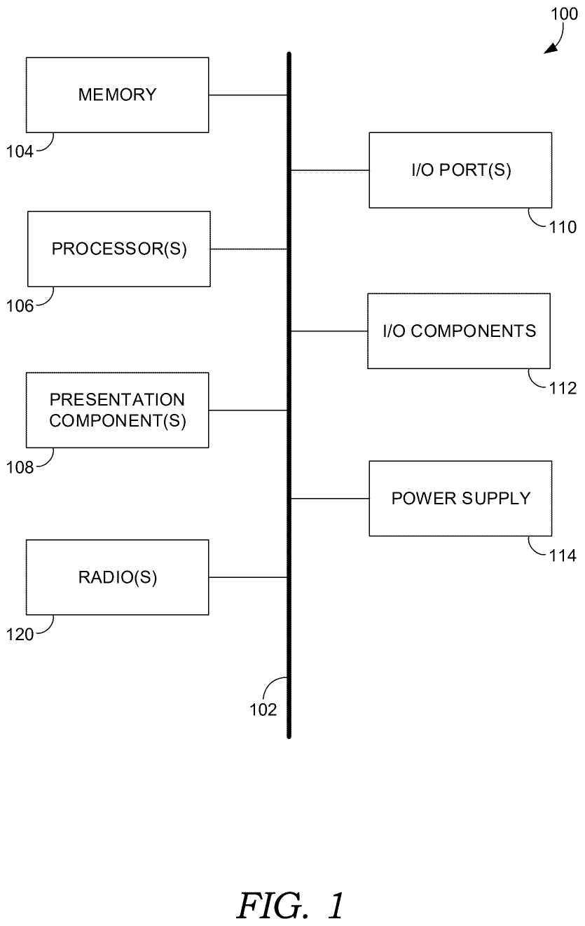

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

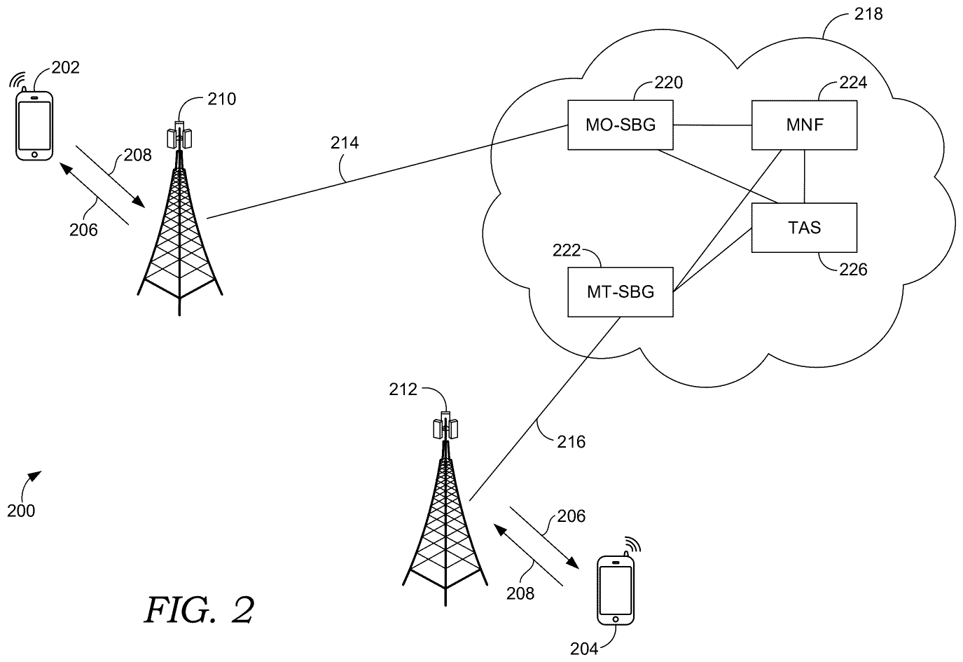

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more base stations, such as a first base station 210 and/or a second base station 212, and a core network 218, though in some implementations, it may not be necessary for certain features to be present. For example, in some aspects, the network environment 200 may not comprise the second base station 212 where the first UE 202 and the second UE 204 each connect to the first base station 210. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1.

The network environment 200 comprises one or more of the first base station 210 and/or the second base station 212 to which the first UE 202 and the second UE 204 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Each of the first base station 210 and the second base station 212 of the network environment 200 is configured to wirelessly communicate with UEs, such as the first UE 202 and/or the second UE 204. In aspects, the first base station 210 and the second base station 212 may communicate with one or more of the first UE 202 and/or the second UE 204 using any wireless telecommunication protocol desired by a network operator, including but not limited to 3G, 4G, 5G, 6G, 802.11x and the like.

Each of the first base station 210 and the second base station 212 is configured to communicate with one or more UEs, such as the first UE 202 and/or the second UE 204. The first base station 210 and/or the second base station 212 may communicate signals to one or more UEs via a downlink 206 and receive signals from one or more UEs via uplink 208. In response to receiving certain requests from the first UE 202 and/or the second UE 204, the first base station 210 and/or the second base station 212 may communicate with the core network 218 via a first backhaul 214 and a second backhaul 216. For example, in order for the first UE 202 to connect to a desired network service (e.g., PSTN call, voice over LTE (VoLTE) call, voice over new radio (VoNR), data, or the like), the first UE 202 may communicate an attach request to the first base station 210, which may, in response, communicate a registration request to the core network 218 via the first backhaul 214.

One or more network functions (NFs) of the core network 218 may communicate messages to other NFs within the core network 218. As used herein, the term “network function” is used to describe a computer processing module and/or one or more computer executable services being executed on one or more computing processing modules. In aspects, the core network 218 is an IP Multimedia Subsystem (IMS) network. The core network 218 may comprise NFs that include any one or more of a mobile-originating session border gateway (MO-SBG) 220, a mobile-terminating session border gateway (MT-SBG) 222, a media resource function (MRF) 224, and a telephony application server (TAS) 226. Each of the preceding NFs may take different forms, including consolidated or distributed forms that perform the same general operations. In other architectures or protocols, the NFs may be given other names, however, the NFs herein refer to functions, not specifically identified components. Though the MO-SBG 220, the MT-SBG 222, the MRF 224, and the TAS 226 are illustrated in the core network 218, the core network 218 may have more or fewer NFs than shown. For example, the core network 218 may include a call session control function (CSCF), an access and mobility management function (AMF), a mobility management entity (MME), and the like. Further, though the MO-SBG 220, the MT-SBG 222, the MRF 224, and the TAS 226 are illustrated as disposed within the core network 218, it is expressly contemplated that the location in the network environment 200 is non-limiting. For example, the NFs described above may be disposed between the first base station 210 and/or the second base station 212 and the core network 218 (i.e., the network edge) or may be isolated as stand-alone components, or a combination of these.

The network core 218 is a service-based architecture and contains NFs defined by their function. The MO-SBG 220 and the MT-SBG 222, for example, are generally responsible for controlling voice call sessions between users, such as the security and quality of service of the voice call session. The MRF 224, for example, is generally responsible for processing media sessions between UEs (e.g., the first UE 202 and/or the second UE 204). The TAS 226, for example, is generally responsible for providing voice session-processing services such as call setup, conferencing, call waiting, and the like. Each of these NFs may communicate with each other, directly or indirectly, via interfaces existing between them. For example, the MRF 224 may communicate with the TAS 226 to establish a voice call session.

The MO-SBG 220 and the MT-SBG 222 may perform various functions relating to call admission control, QoS enforcement, security control, and normalization of protocol messages between NFs. While two SBGs are illustrated within the core network 218, there may be only one SBG that corresponds to both the first UE 202 and the second UE 204. In some aspects, the MO-SBG 220 may be associated with the first UE 202 and the MT-SBG 222 may be associated with the second UE 204. The MO-SBG 220 and the MT-SBG 222 may communicate with other NFs within the core network 218, such as the MRF 224 and/or the TAS 226. The MO-SBG 220 and/or the MT-SBG 222 may facilitate establishing a hybrid session between the first UE 202 and the second UE 204.

The MRF 224 may perform various functions relating to establishing media sessions, such as establishing voice calls, video calls, conference calls, streaming sessions, and the like. While one MRF 224 is illustrated within the core network 218, there may be additional MRFs within the core network 218 or the functions associated with the MRF 224 may be distributed between multiple NFs. The MRF 224 may communicate with other NFs within the core network 218, such as the MO-SBG 220, the MT-SBG 222, and the TAS 226, to establish the hybrid session between the first UE 202 and the second UE 204.

The TAS 226 may perform various function associated with establishing voice call sessions, such as call setup, call waiting, call forwarding, conference calling, termination of calls, and the like. While one TAS 226 is illustrated within the core network 218, there may be additional TASs within the core network 218 or the functions associated with the TAS 226 may be distributed between multiple NFs. The TAS 226 may communicate with other NFs within the core network 218, such as the MO-SBG 220, the MT-SBG 222, and the MRF 224, to establish the hybrid session between the first UE 202 and the second UE 204.

Relevant to the present disclosure, subscribers may wish to communicate using various formats, and may wish to communicate in real-time with more than one subscriber. The NFs within the core network 218 may communicate with each other and/or with the first base station 210 and/or the second base station 212 to establish the hybrid session between the first UE 202 and the second UE 204. The hybrid session may enable subscribers to communicate in real-time using different message formats. For example, a first subscriber may prefer to communicate via text and a second subscriber may prefer via to communicate via audio (e.g., a regular voice call). In this example, during the hybrid session, the first subscriber may send text in real time to the second subscriber, who will receive converted, real-time audio corresponding to the text. In this example, the first subscriber may be driving and reading text on their device would distract them from the road, and the other subscriber may be in a meeting, where audio would distract from the meeting. The hybrid session may further enable subscribers to communicate in real time with more than one subscriber. For example, during the hybrid session, the first subscriber may receive an incoming call, which may be answered without interrupting the hybrid session.

A NF (e.g., the MRF 224) may receive an indication to convert an active voice call session or an incoming voice call session to the hybrid session. In aspects, the indication is caused by a session initiation protocol (SIP) invite message originating from the second UE 204 being received by one or more NFs and/or the first UE 202 (e.g., when the first UE 202 wishes to answer an incoming call from the second UE 204 with the hybrid session). In other aspects, the indication is caused by a SIP invite message originating from a third UE to the first UE 202. For example, the first UE may wish to convert an existing voice call session between the first UE 202 and the second UE 204 to the hybrid session to answer an incoming voice call session between the first UE 202 and the third UE. In some aspects, the indication may be caused by the first UE 202 and/or the second UE 204 requesting a hybrid session be created for an existing voice call session or an incoming voice call session (e.g., a subscriber operating the first UE presses an option on a user interface requesting the hybrid session be established).

The hybrid session may comprise at least a first session type and a second session type. The first session type may comprise a rich communication service (RCS) session between the first UE 202 and one or more NFs within the core network 218. RCS is generally a messaging protocol with features such as delivery status notifications, read receipts, typing indicators, and the like. In aspects, the RCS session is established between the first UE 202 and the MRF 224. The second session type may comprise a real-time text (RTT) session between the second UE 204 and one or more NFs within the core network 218. RTT is generally a messaging technology with real-time features. For example, in a conventional RTT session, the second UE 204 would view, in real time, the first UE 202 text the first message, without the subscriber operating the first UE 202 pressing a “send” button. In aspects, the RTT session is established between the second UE 204 and the MRF 224. The first UE 202 and the second UE 204 may communicate in real time via the hybrid session. In some aspects, the first UE 202 may answer an incoming call with the hybrid session, and in other aspects, an existing voice call session may be converted to the hybrid session. In some aspects, an existing voice call session may be converted to the hybrid session for the purpose of answering a voice call session between the first UE 202 and a third UE.

The hybrid session may be anchored to one or more NFs. In aspects, the RCS session and the RTT session are anchored together to the one or more NFs via a single bearer. In some aspects, the one or more NFs may comprise a text to speech (TTS) module configured to convert incoming text to corresponding audio in real time. In aspects, the one or more NFs may comprise a speech to text (STT) module, such as an automatic speech recognition module (ASR) module, configured to convert incoming audio to corresponding text in real time. In some aspects, the one or more NFs may comprise both a TTS module and a STT module. In some aspects, the STT/TTS module may learn voice characteristics of subscribers (e.g., the subscribers associated with each of the first UE 202 and/or the second UE 204) and convert received text to synthetic speech resembling a voice associated with the subscribers. In other aspects, the one or more NFs may communicate with a TTS and/or STT module or one or more NFs comprising a TTS and/or STT module. The one or more NFs may be any one or more of the MO-SBG 220, the MRF 224, the TAS 226, and/or the MT-SBG 222.

The one or more NFs within the core network 218 (e.g., the MRF 224, the MO-SBG 220) may be configured to receive a first message from the first UE 202 via the RCS session. The first message may comprise a text from the first UE 202. For example, the first message may be a text string “hello.” The first message may be received by the one or more NFs via the RCS session by the subscriber operating the first UE 202 and typing the text string into a messaging interface. The one or more NFs may be any one or more of the MO-SBG 220, the MT-SBG 222, the MRF 224, and/or the TAS 226.

One or more NFs within the core network 218 may communicate a second message to the second UE 204 via the RTT session. In some aspects, the content and format of the second message are the same as the first message (e.g., the first message is not converted to another format). For example, the second message may be a text string saying “hello.” In such aspects, non-substantive message information of the first message may be altered (e.g., altering the header of the first message to be compatible with the RTT session) while the substantive information (i.e., the actual message) is not altered. In other aspects, the one or more NFs (e.g., the MRF 224) may convert the first message to the second message, such as converting the text string to corresponding audio. For example, the text sent by the first UE 202 is converted to an audio corresponding with the first text (e.g., a text-to-speech audio message “hello”). The one or more NFs may communicate the second message (e.g., text string, corresponding audio) to the second UE 204 via the RTT session.

The one or more NFs within the core network 218 may be configured to receive a third message from the second UE 204 via the RTT session (e.g., in response to the first message from the first UE 202). In some aspects, the third message is an audio from the second UE 204. For example, in response to a TTS audio message, the second UE 204 provides an audio message (e.g., the subscriber operating the second UE 204 verbally responds to the first message from the first UE 202). In other aspects, the third message is a text from the second UE 204.

The one or more NFs may communicate a fourth message to the first UE 202 via the RCS session (e.g., the second UE's 202 response to the first message from the first UE 202). In some aspects (e.g., where the third message is an audio), the one or more NFs may convert the third message (e.g., audio received from the subscriber operating the second UE 204) to a text (e.g., a STT-generated text corresponding to the audio from the second UE 204). In other aspects (e.g., where the third message is a text), the content and format of the fourth message are the same as the third message. In such aspects, non-substantive message information of the third message may be altered (e.g., altering the header of the third message to be compatible with the RCS session) to generate the fourth message. The one or more NFs may communicate the fourth message (e.g., STT-generated text, a text) to the first UE 202.

In some aspects, once the subscribers associated with either the first UE 202 and/or the second UE 204 are finished communicating via the hybrid session, the first UE 202 and/or the second UE 204 may select to terminate the hybrid session. In other aspects, the one or more NFs may terminate the hybrid session. For example, the one or more NFs may terminate the hybrid session upon no messages being communicated for a pre-determined time, such as five minutes, ten minutes, and the like. In another example, the one or more NFs may terminate the hybrid session upon the one or more NFs experiencing network congestion. In some aspects, upon termination of the hybrid session, the first UE 202 and the second UE 204 return to an active voice call session, and in other aspects, the first UE 202 and the second UE 204 end the hybrid session and are not returned to an active voice call session (e.g., the communication is terminated).

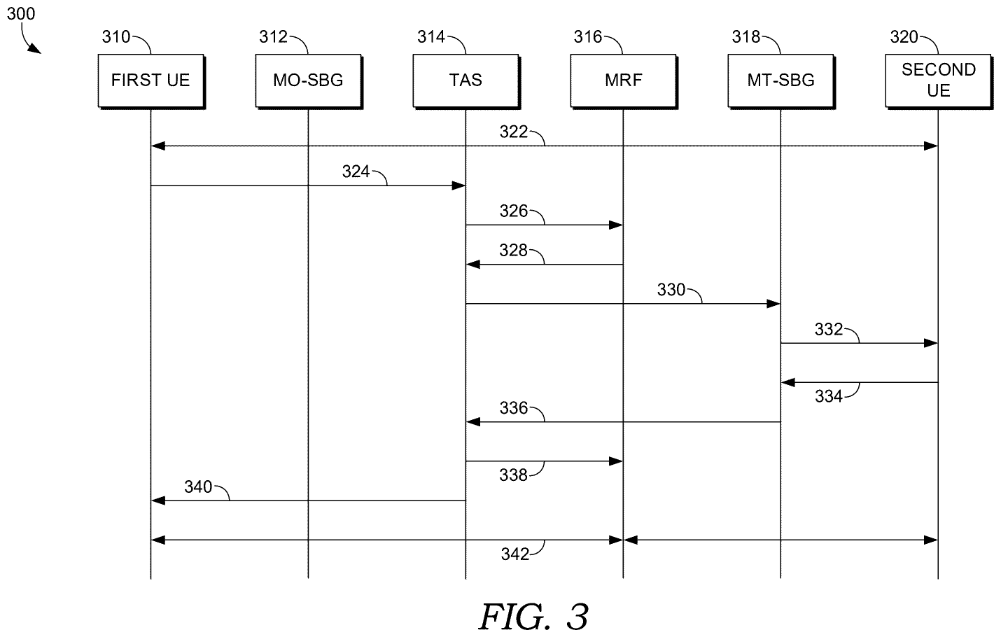

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may generally include a first UE 310 (e.g., the first UE 202 of FIG. 2), a MO-SBG 312 (e.g., the MO-SBG 220 of FIG. 2), a TAS 314 (e.g., the TAS 226 of FIG. 2), a MRF 316 (e.g., the MRF 224 of FIG. 2), a MT-SBG 318 (e.g., the MT-SBG 222 of FIG. 2), and a second UE 320 (e.g., the second UE 204 of FIG. 2). Each of the preceding NFs may take different forms, including consolidated or distributed forms that perform the same general operations. In other architectures or protocols, the NFs may be given other names, however, the NFs herein refer to functions, not specifically identified components.

At a first step 322, a first voice call session is established between the first UE 310 and the second UE 320. For example, the first UE 310 and the second UE 320 are each participating in an active voice call session such that each subscriber of the first UE 310 and the second UE 320 may verbally communicate in real time during the first voice call session. During the first voice call session, one or more NFs may receive an indication to convert the first voice call session to a hybrid session. The hybrid session may have one or more aspects as described with respect to FIG. 2. In some aspects, the indication to convert the first voice call session may be an incoming second voice call session from a third UE. In other aspects, the subscriber associated with the first UE 310 may wish to proceed with the first voice call session using the hybrid session, and my cause the indication by pressing an interface of the first UE (e.g., presses a button “switch to hybrid session”).

One or more NFs within the core network (e.g., the core network 218 of FIG. 2) may exchange messages to establish the hybrid session. In aspects, the messages exchanged while establishing the hybrid session may be exchanged via one communication protocol, such as session initiation protocol (SIP), diameter, H.323, web real-time communication (WebRTC), media gateway control protocol (MGCP), and the like. In other aspects, the messages exchanged while establishing the hybrid session may be exchanged according to various protocols. In some aspects, the network components within the call flow 300 may directly communicate messages to one another, and in other aspects, the network components may communicate messages to one or more intermediate NFs, and the one or more intermediate NFs may communicate messages to the receiving network component (i.e., indirect communication).

At a second step 324, the first UE 310 may send a first communication to the TAS 314. The first communication may be a “SIP INVITE” message originating from the first UE 310 and communicated to the TAS 314 to initiate establishment of the hybrid session. The first communication may contain one or more headers containing information relevant to the exchange of the first communication (e.g., via, to, from, call-ID, cseq, contact, content-type, content-length headers). In some aspects, the first communication may include session information describing or identifying the type of session, such as the hybrid session. The session information may be found within the one or more headers and/or the payload of the first communication. In other aspects, the first communication may be embedded with session description protocol (SDP) information, such as connection information, session types, codec formats, media formats, transport protocols, and the like. The type of session may include the type of media session, such as the hybrid session using both text and speech inputs.

At a third step 326, the TAS 314 may send a second communication to the MRF 316. In some aspects, the second communication is the same as the first communication (i.e., the TAS 314 forwards the first communication to the MRF 316). In other aspects, the second communication is a modified version of the first communication. For example, the first communication may be altered (e.g., header information, payload) at the TAS 314 to generate the second communication, which is then communicated to the MRF 316. In some aspects, the second communication informs the MRF 316 of the first UE 310's request to change the active voice session to the hybrid session.

At a fourth step 328, the MRF 316 sends a third communication (e.g., a SIP INFO message) to the TAS 314 to convey transcoding information. For example, the transcoding information may include one or more codecs the MRF 316 will employ during the hybrid session. For example, the MRF 316 may notify the TAS 314 of the one or more codecs the MRF 316 will use, codec configurations, relevant session parameters, and the like. In aspects, the codecs employed by the MRF 316 may assist in converting typed text into speech audio and/or may assist in converting spoken speech audio into text (e.g., compression, encoding, decoding).

At a fifth step 330, the TAS 314 sends a fourth communication to the MT-SBG 318. In aspects, the fourth communication is a SIP UPDATE message. The fourth communication may be received by the MT-SBG 318 and may instruct the MT-SBG 318 to update various session parameters. The fourth communication may instruct the update or change of session parameters such as codecs or media types during the hybrid session. For example, the fourth communication may instruct the MT-SBG 318 communicate in a manner consistent with the one or more codecs being used during the hybrid session and/or instruct the MT-SBG 318 to receive and/or communicate using one or more media types during the hybrid session.

At a sixth step 332, the MT-SBG 318 sends a fifth communication to the second UE 320. In aspects, the fifth communication is a SIP UPDATE message. In some aspects, the fifth communication is the same as the fourth communication, and in other aspects, the fifth communication is different from the fourth communication. In some aspects, the fifth communication may request approval to convert the active voice call session to the hybrid session. In such aspects, the second UE 320, in response to receiving the fifth communication, may display the request to convert to the hybrid session to the subscriber operating the second UE 320, and the subscriber may accept or deny the request to convert to the hybrid session. The subscriber may accept or deny the request to convert by pressing one or more designated buttons on an interface of the second UE 320. The fifth communication may additionally or alternatively request the second UE 320 use one or more media types during the hybrid session. For example, the fifth communication may request the second UE 320 provide audio media (e.g., spoken speech) in response to written text provided by the first UE 310.

At a seventh step 334, the second UE 320 sends a sixth communication to the MT-SBG 318. In aspects, the sixth communication is a 200 OK message in response to the fifth communication. For example, the fifth communication may request the subscriber associated with the second UE 320 approve or deny a request to convert the voice call session to the hybrid session, and the sixth communication may indicate an acceptance of the request. In response, the second UE 320 communicates the 200 OK message. In other aspects, the sixth communication is a 603 Decline or 487 Request Terminated message, such as when the subscriber associated with the second UE 320 rejects the request to convert the voice call session to the hybrid session. For purposes of describing the remaining call flow 300, the second UE 320 accepts the request to convert the audio session to the hybrid session.

At an eighth step 336, the MT-SBG 318 sends a seventh communication to the TAS 314. In aspects, the seventh message is a 200 OK message in response to the fifth communication from the TAS 314. In some aspects, the seventh communication may confirm to the TAS 314 that the fifth communication was received by the second UE 320. Further, the seventh message may inform the TAS 314 that the second UE 320 has accepted the changes or requests of the fifth communication. For example, the fifth communication may have requested the subscriber associated with the second UE 320 approve or deny a request to convert the voice call session to the hybrid session, and the seventh communication communicates the second UE 320's acceptance of the request. In other examples, the seventh communication may confirm the second UE 320 has updated to use a different media type during the hybrid session. In some aspects, the seventh communication may both inform the TAS 314 of the second UE's acceptance of configuration changes and acceptance of the request to convert to the hybrid session.

At a ninth step 338, the TAS 314 communicates an eighth communication to the MRF 316. In aspects, the eighth communication is a SIP INFO message. In some aspects, the eighth communication may notify the MRF 316 that the second UE 320 has accepted the request to convert the active voice call into the hybrid session. The MRF 316 may be notified of the second UE 320's acceptance such that the MRF 316 is informed to use the proper session parameters, codecs, protocols, and the like to enable the first UE 310 and the second UE 320 to communicate during the hybrid session. For example, the eighth communication may notify the MRF 316 that the second UE 320 has accepted the request to convert the active voice call session to the hybrid session such that the MRF 316 can employ one or more codecs involved in converting text to speech or speech to text during the hybrid session.

At a tenth step 340, the TAS 314 sends a ninth communication to the first UE 310. In aspects, the ninth communication is a 200 OK message. In some aspects, the ninth communication indicates to the first UE 310 that the second UE 320 has accepted the request to convert the active voice session to the hybrid session. In other aspects, the ninth communication confirms to the first UE 310 that the hybrid session has been configured such that the first UE 310 and the second UE 320 can communicate via the hybrid session. In some aspects, the ninth communication may both notify the first UE 310 that the second UE 320 has accepted the request and that the hybrid session has been configured for communication with the second UE 320.

At an eleventh step 342, the hybrid session is established between the first UE 310 and the second UE 320. During the hybrid session, the first UE 310 may send messages (e.g., the first message as described with respect to FIG. 2) via text, which are received by the MRF 316. The MRF 316 may include a TTS module and a STT module, or be in communication with the TTS module and the STT module, as described with respect to FIG. 2. The MRF 316 may convert the first message to the second message, as described with respect to FIG. 2. The MRF 316 may communicate the second message to the second UE 320, as described with respect to FIG. 2. In response, the second UE 320 may communicate a third message (e.g., spoken audio) to the MRF 316. The MRF 316 may convert the third message to a fourth message (e.g., text corresponding to the audio), as described with respect to FIG. 2. The MRF 316 may communicate the fourth message to the first UE 310.

In some aspects, once the hybrid session is established, the first UE 310 may answer another call (e.g., the second voice call). For example, during the hybrid session between the first UE 310 and the second UE 320, a third UE may call the first UE 310. The first UE 310 may establish a voice call session with the third UE while continuing to communicate with the second UE 320 via the hybrid session (e.g., via text). In other aspects, once the hybrid session is established, the first UE 310 may make another call. For example, once the hybrid session is established, the first UE 310 may communicate a SIP INVITE message to a third UE. In some aspects, the indication to convert the first voice call session to the hybrid session is caused by a third UE requesting a second voice call session with the first UE 310.

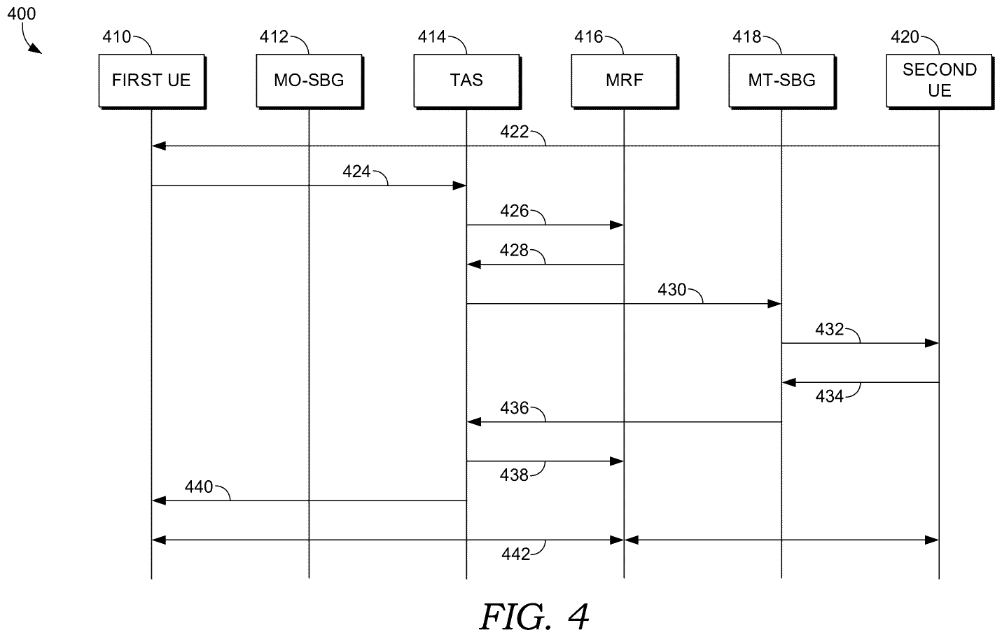

Turning now to FIG. 4, a call flow diagram is illustrated in accordance with one or more aspects of the present disclosure. A call flow 400 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 400 may generally include a first UE 410 (e.g., the first UE 202 of FIG. 2, the first UE 310 of FIG. 3), a MO-SBG 412 (e.g., the MO-SBG 220 of FIG. 2, the MO-SBG 312 of FIG. 3), a TAS 414 (e.g., the TAS 226 of FIG. 2, the TAS 314 of FIG. 3), a MRF 416 (e.g., the MRF 224 of FIG. 2, the MRF 316 of FIG. 3), a MT-SBG 418 (e.g., the MT-SBG 222 of FIG. 2, the MT-SBG 318 of FIG. 3), and a second UE 420 (e.g., the second UE 204 of FIG. 2, the second UE 320 of FIG. 3). Each of the preceding NFs may take different forms, including consolidated or distributed forms that perform the same general operations. In other architectures or protocols, the NFs may be given other names, however, the NFs herein refer to functions, not specifically identified components.

At a first step 422, one or more NFs may receive an indication to convert the incoming voice call session to a hybrid session, as described with respect to FIG. 2. In aspects, the indication is an incoming call between the first UE 410 and the second UE 420. For example, the second UE 420 dials a number associated with the first UE 410. In some aspects, a SIP invite message from the second UE 420 may act as the indication to convert the incoming voice call session to the hybrid session, as described with respect to FIG. 2. In other aspects, the indication may be caused by the subscriber operating the first UE 410 pressing an option within the first UE's 410 interface to convert the incoming voice call session to the hybrid session.

At a second step 424, the first UE 410 may send a first communication to the TAS 414, as described with respect to FIG. 3. In aspects, the first communication is sent to the TAS 414 in response to the indication to convert the incoming voice call session to the hybrid session. At a third step 426, the TAS 414 may send a second communication to the MRF 416, as described with respect to FIG. 3. At a fourth step 428, the MRF 416 sends a third communication to the TAS 414, as described with respect to FIG. 3. At a fifth step 430, the TAS 414 sends a fourth communication to the MT-SBG 418, as described with respect to FIG. 3. At a sixth step 432, the MT-SBG 418 sends a fifth communication to the second UE 420, as described with respect to FIG. 3. At a seventh step 434, the second UE 420 sends a sixth communication to the MT-SBG 418, as described with respect to FIG. 3. At an eighth step 436, the MT-SBG 418 sends a seventh communication to the TAS 414, as described with respect to FIG. 3. At a ninth step 438, the TAS 414 communicates an eighth communication to the MRF 416, as described with respect to FIG. 3. At a tenth step 440, the TAS 414 sends a ninth communication to the first UE 410, as described with respect to FIG. 3. At an eleventh step 442, the hybrid session is established between the first UE 410 and the second UE 420, as described with respect to FIG. 3.

In some aspects, once the incoming voice call session is converted to the hybrid session, the first UE 410 may participate in a voice call session. For example, the first UE 410 and the second UE 420 communicate via the hybrid session (e.g., the first UE 410 inputs text, the MRF 416 converts the text to spoken audio, and the second UE 420 receives spoken audio corresponding to the text), and the first UE 410 may concurrently initiate a voice call session by calling a number associated with a third UE. In other aspects, the first UE 410 may answer a second incoming voice call session while communicating with the second UE 420 during the hybrid session.

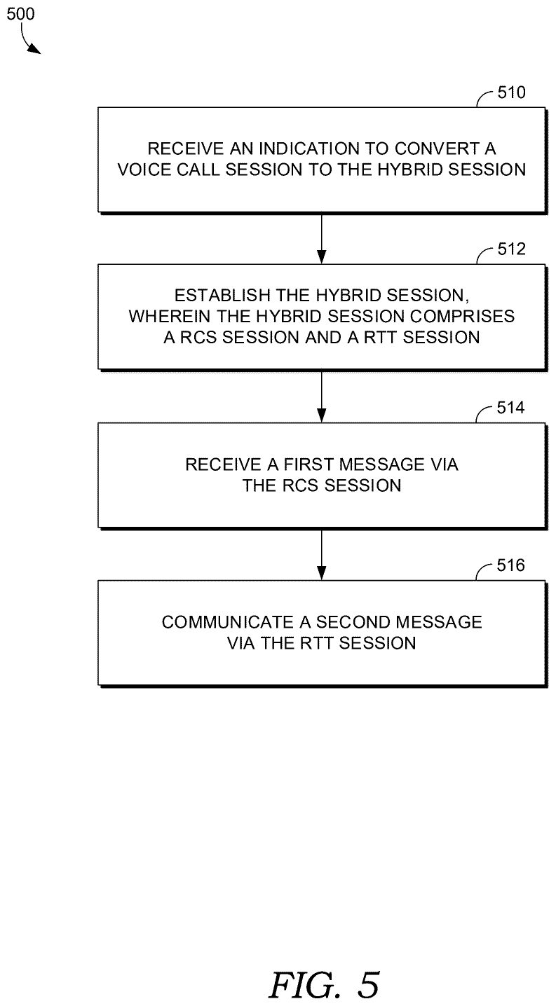

Turning now to FIG. 5, a flow chart is provided that illustrates one or more aspects of the present disclosure relating to a method 500 of establishing a hybrid session. The method 500 may incorporate one or more aspects of FIGS. 1-4. At a first step 510, one or more NFs receive an indication to convert a voice call session to a hybrid session, as described with respect to FIGS. 2-4. In some aspects, the indication is to convert an active voice call session to the hybrid session, and in other aspects, the indication is to convert an incoming voice call session to the hybrid session. At a second step 512, the one or more NFs establish the hybrid session, as described with respect to FIGS. 3-4. The hybrid session may comprise both an RCS session and a RTT session, and each session may be anchored to one or more NFs (e.g., the MRF 316 of FIG. 3, the MRF 416 of FIG. 4). The hybrid session may be established between a first UE and a second UE (e.g., the first UE 310 and second UE 320 of FIG. 3, the first UE 410 and second UE 420 of FIG. 4).

At a third step 514, the one or more NFs may receive a first message via the RCS session. In aspects, the first message is a text string communicated from the first UE to the one or more NFs. The one or more NFs may comprise or be in communication with a TTS/STT module, and the one or more NFs may convert the first message to a second message via the TTS module. At a fourth step 516, the one or more NFs may communicate the second message via the RTT session. In aspects, the second message is communicated to the second UE. In aspects, the second message is a converted speech audio of the first message. In aspects, the second UE may respond to the second message via spoken speech or via text via the RTT session, as described with respect to FIG. 2.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for converting a first voice call session to a hybrid session, the method comprising:
receiving, at a network function, an indication to convert the first voice call session between a first UE and a second UE to the hybrid session;
converting, based on the indication, the first voice call session between the first UE and the second UE to the hybrid session, wherein the hybrid session comprises a rich communication service (RCS) session and a real-time text (RTT) session;
establishing a second voice call session between the first UE and a third UE;
receiving, via the hybrid session, a first text from the first UE;
converting, via the hybrid session, the first text from the first UE to a first audio; and
communicating, via the hybrid session, the first audio to the second UE.

2. The method of claim 1, further comprising:
receiving a second audio from the second UE;
converting the second audio to a second text; and
communicating the second text to the first UE.

3. The method of claim 1, further comprising:
receiving a second text from the second UE; and
communicating the second text to the first UE.

4. The method of claim 1, further comprising notifying the second UE that the first voice call session is being converted to the hybrid session.

5. The method of claim 1, wherein the indication is caused by a session initiation protocol (SIP) invite message from the third UE being communicated to the first UE.

6. The method of claim 1, wherein the network function comprises a text to speech module.

7. A method for converting a voice call session to a hybrid session, the method comprising:
receiving, at a network function, an indication to convert the voice call session between a first UE and a second UE to the hybrid session;
establishing, based on the indication, the hybrid session, wherein the hybrid session comprises a rich communication service (RCS) session between the first UE and the network function and a real-time text (RTT) session between the second UE and the network function;
receiving a first message from the first UE via the RCS session; and
communicating a second message to the second UE via the RTT session.

8. The method of claim 7, further comprising:
receiving a third message from the second UE via the RTT session; and
communicating a fourth message to the first UE via the RCS session.

9. The method of claim 7, wherein the first message is converted to the second message, wherein the first message is a first text, and wherein the second message is a first audio corresponding to the first text.

10. The method of claim 7, wherein the first message and the second message are text, and wherein a substantive content of the first message and the second message are the same.

11. The method of claim 8, wherein the third message is converted to the fourth message, wherein the third message is a second audio, and the fourth message is a second text corresponding to the second audio.

12. The method of claim 7, wherein the network function is a media resource function (MRF).

13. The method of claim 7, wherein the network function comprises a text to speech module.

14. A method for converting an incoming voice call session to a hybrid session, the method comprising:
receiving, at a network function, an indication to convert the incoming voice call session between a first UE and a second UE to the hybrid session;
establish, based on the indication, the hybrid session, wherein the hybrid session comprises a rich communication service (RCS) session between the first UE and the network function and a real-time text (RTT) session between the second UE and the network function;
receive a first message from the first UE via the RCS session; and
communicating a second message to the second UE.

15. The method of claim 14, further comprising:
receiving a third message from the second UE via the RTT session; and
communicating a fourth message to the first UE via the RCS session.

16. The method of claim 14, wherein the first message is converted to the second message, wherein the first message is a first text, and wherein the second message is a first audio corresponding to the first text.

17. The method of claim 14, wherein the first message and the second message are text, and wherein a substantive content of the first message and the second message are the same.

18. The method of claim 15, wherein the third message is converted to the fourth message, wherein the third message is a second audio, and the fourth message is a second text corresponding to the second audio.

19. The method of claim 16, further comprising communicating a delivery status notification to the first UE, wherein the delivery status notification corresponds to a time when the first message has been converted to the second message.

20. The method of claim 14, further comprising establishing a voice session between the first UE and a third UE.
